(19) United States
(12) Patent Application Publication
(10) Pub. No.: US 2014/0184547 A1
(43) Pub. Date: Jul. 3, 2014

(54) INFORMATION PROCESSOR AND DISPLAY CONTROL METHOD

(71) Applicant: Kabushiki Kaisha Toshiba, Tokyo (JP)

(72) Inventor: Masayuki TOKUNAGA, Tokyo (JP)

(73) Assignee: Kabushiki Kaisha Toshiba, Tokyo (JP)

(21) Appl. No.: 14/160,523

(22) Filed: Jan. 21, 2014

(30) Foreign Application Priority Data
Dec. 27, 2012 (JP) 2012285991

(51) Int. Cl. G09G 5/14

(52) U.S. Cl. CPC G09G 5/14
USPC 345/173

(57) ABSTRACT

According to one embodiment, information processor includes touch panel, display, and transmitter. The touch panel corresponds to each of plurality of display areas and is capable of detecting operation by touch operation with respect to the display areas. A first display screen of external display device is split as the display areas. The display includes a second display screen displaying a plurality of operating area images that make operating areas corresponding to the respective display areas identifiable on the touch panel . The touch panel is arranged on second display screen side. The transmitter transmits, upon detection of the operation by which changing size of at least one of the operating areas is instructed, a change instruction by which changing size of at least one of the display areas corresponding to the at least one of the operating areas having the changed size is instructed, to the external display device.

### CROSS-REFERENCE TO RELATED APPLICATIONS

This application is a national stage of International Application No. PCT/JP2013/058426, filed on Mar. 22, 2013, which designates the United States, incorporated herein by reference, and which is based upon and claims the benefit of priority from Japanese Patent Application No. 2012-285991, filed on Dec. 27, 2012, the entire contents of which are incorporated herein by reference.

### FIELD

Embodiments of the present invention relates to an information processor and a display control method.

### BACKGROUND

There has been disclosed a technique in which a display comprised in an information processor capable of operating an external display device that displays a plurality of images is provided with a plurality of operating areas that correspond to the images displayed on the external display device and that is capable of receiving an operation with respect to each of the images. According to such technique, the operating areas are arranged on the display in a manner so as to be able to visually recognize one-to-one correspondence relation between the images displayed on the external display device and the operating areas.

In the technique that arranges the operating areas on the display so as to be able to visually recognize the one-to-one correspondence relation between the images displayed on the external display device and the operating areas, there is a demand in which the operation to change the display size of the images displayed on the external display device can be performed intuitively on the display of the information processor.

### BRIEF DESCRIPTION OF DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating a configuration of a display control system according to a first embodiment;

FIG. 2A is an exemplary diagram illustrating a splitting example of a first display screen on an external display device in the first embodiment;

FIG. 2B is an exemplary diagram illustrating a splitting example of the first display screen on the external display device in the first embodiment;

FIG. 2C is an exemplary diagram illustrating a splitting example of the first display screen on the external display device in the first embodiment;

FIG. 3A is an exemplary diagram illustrating a splitting example of the first display screen on the external display device in the first embodiment;

FIG. 3B is an exemplary diagram illustrating a splitting example of the first display screen on the external display device in the first embodiment;

FIG. 4 is an exemplary block diagram illustrating a hardware configuration of an operating device in the first embodiment;

FIG. 5 is an exemplary flowchart illustrating a sequence of a process to control the display on the first display screen of the external display device performed by the operating device in the first embodiment;

FIG. 6 is an exemplary diagram illustrating one example of the first display screen of the external display device and a second display screen of the operating device in the display control system in the first embodiment;

FIG. 7 is an exemplary diagram illustrating one example of the first display screen of the external display device and the second display screen of the operating device in the display control system in the first embodiment;

FIG. 8A is an exemplary diagram illustrating one example of operating areas that a touch panel of the operating device has, in the first embodiment;

FIG. 8B is an exemplary diagram illustrating one example of the operating areas that the touch panel of the operating device has, in the first embodiment;

FIG. 9 is an exemplary diagram for explaining the operation to resize the display area in response to the resizing of the operating area in the display control system in the first embodiment;

FIG. 10 is an exemplary diagram for explaining the operation to change the layout of the display areas in response to the change in the layout of the operating areas in the display control system in the first embodiment;

FIG. 11 is an exemplary diagram for explaining the operation to switch the target of operation to a single display area or to all of a plurality of display areas in a display control system according to a first modification; and

FIG. 12 is an exemplary diagram illustrating a display example of an image for a second display screen of an operating device according to a second modification.

### DETAILED DESCRIPTION

In general, according to one embodiment, an information processor comprises a touch panel, a display, and a transmitter. The touch panel is configured to correspond to each of a plurality of display areas and to be capable of detecting an operation by touch operation with respect to the display areas . The first display screen of an external display device is split as the display areas. The display comprises a second display screen displaying a plurality of operating area images configured to make operating areas corresponding to the respective display areas identifiable on the touch panel . The touch panel is arranged on a second display screen side. The transmitter is configured to transmit, upon detection of the operation by which changing a size of at least one of the operating areas is instructed, a change instruction by which changing a size of at least one of the display areas corresponding to the at least one of the operating areas having the changed size is instructed, to the external display device.

With reference to the accompanying drawings, an information processor and a display control method according to a present embodiment will be described hereinafter.

### First Embodiment

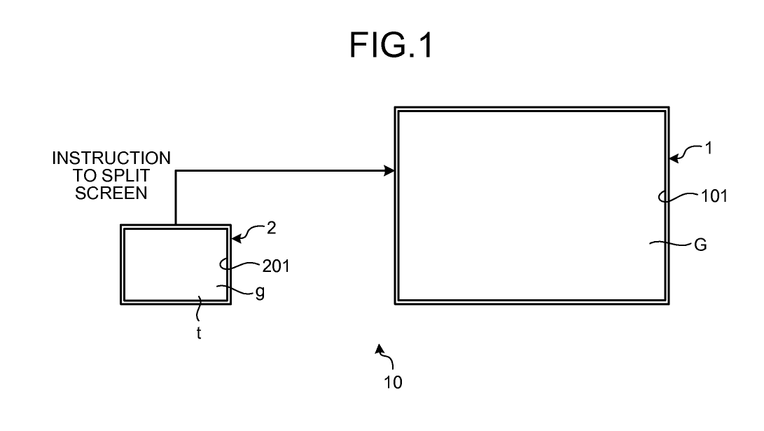

FIG. 1 is a block diagram illustrating a configuration of a display control system according to a first embodiment. A display control system 10 in the first embodiment comprises an external display device 1 (for example, a television) and an operating device 2 (for example, a portable terminal device such as a tablet device or a smartphone). The external display device 1 comprises a display module 101 comprising a display screen (hereinafter, referred to as a first display screen G) displaying a variety of display information such as broadcast video. The operating device 2 is an example of an information processor that allows the operation for the external display device 1 to be input.

In the first embodiment, the external display device 1 splits the first display screen G into a plurality of display areas in response to a split screen instruction that instructs the splitting of the first display screen G from the operating device 2. The external display device 1 then displays a variety of display information in the split display areas. The split screen instruction includes the number of splits when the first display screen G is split into the display areas, and layout information indicating the layout of the respective display areas on the first display screen G. In each of the display areas of the split first display screen G, a process concerning the display information displayed in the display area (for example, switching the display information and changing the volume of sound concerning the display information) is operable for each display area.

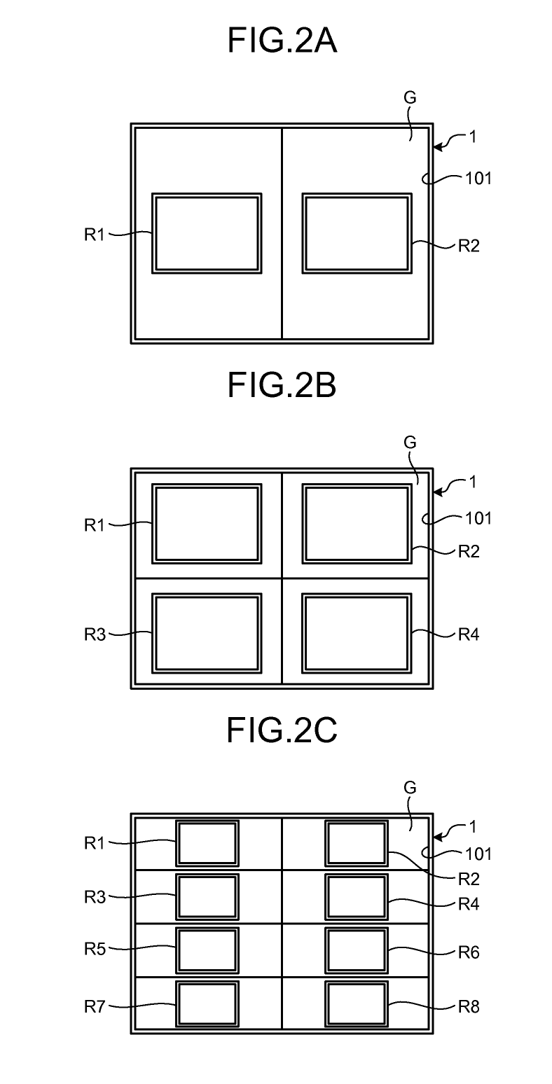

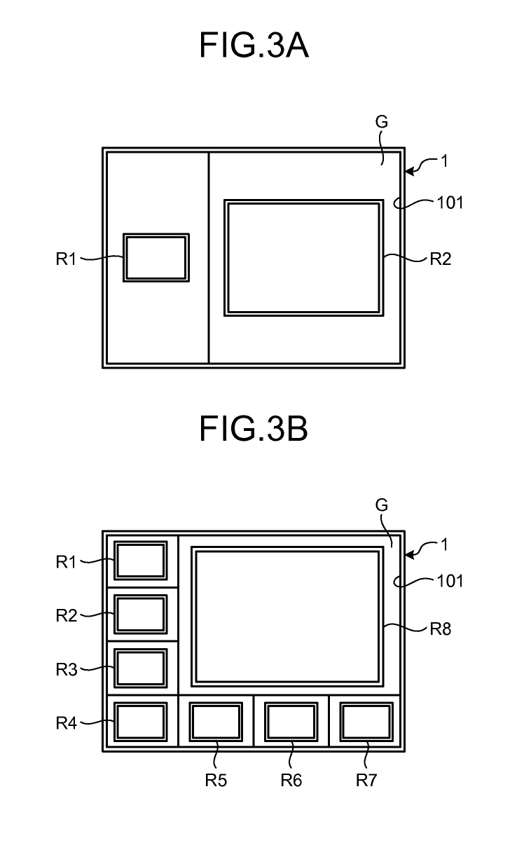

FIGS. 2A, 2B, 2C, 3A, and 3B are diagrams illustrating splitting examples of the first display screen of the external display device in the first embodiment. For example, as illustrated in FIG. 2A, when the external display device 1 receives a split screen instruction that includes the number of splits of two, the external display device 1 splits the first display screen G into two display areas R1 and R2 of an equal display size. Furthermore, as illustrated in FIG. 2B, when the external display device 1 receives a split screen instruction that includes the number of splits of four, the external display device 1 splits the first display screen G into four display areas R1, R2, R3, and R4 of an equal display size. Moreover, as illustrated in FIG. 2C, when the external display device 1 receives a split screen instruction that includes the number of splits of eight, the external display device 1 splits the first display screen G into eight display areas R1, R2, R3, R4, R5, R6, R7, and R8 of an equal display size.

While the first display screen G is split into the display areas of the equal display sizes in the splitting examples of the first display screen G illustrated in FIGS. 2A, 2B, and 2C, the display sizes are not limited as such. For example, as illustrated in FIG. 3A, when the external display device 1 receives a split screen instruction that includes the number of splits of two, the external display device 1 splits the first display screen G into two display areas R1 and R2 of different display sizes. Furthermore, as illustrated in FIG. 3B, when the external display device 1 receives a split screen instruction that includes the number of splits of eight, the external display device 1 splits the first display screen G into seven display areas R1, R2, R3, R4, R5, R6, and R7, and a display area R8 of a display size larger than those of the foregoing display areas.

While the external display device 1 splits the first display screen G into a plurality of display areas in response to a split screen instruction from the operating device 2 in the first embodiment, the embodiment is not limited to this. For example, the external display device 1 can split the first display screen G into a plurality of display areas in response to a split screen instruction from a remote controller (not depicted) that is capable of operating the external display device 1. At that time, the external display device 1 transmits the layout information indicating the number of splits of the display areas of the first display screen G split and the layout of the respective display areas on the first display screen G to the operating device 2.

The operating device 2 is an example of an information processor in which the operation for the external display device 1 can be input, and the operating device 2 transmits various instructions (for example, a split screen instruction, a return instruction to return from a state of the first display screen G being split into a plurality of display areas to a state of the first display screen G displaying a single piece of display information, a change instruction to change the volume of sound concerning the display information displayed on the first display screen G, and a change instruction that specifies the switching of the display information displayed on the first display screen G) to the external display device 1 in a wired or wireless manner in response to the operation input.

The operating device 2 comprises, as illustrated in FIG. 1, a touch panel t capable of detecting an operation by touch operation, and a display module 201 provided with the touch panel t and comprising a second display screen g capable of displaying thereon a variety of information. The touch panel t corresponds to each of the display areas that are the first display screen G being split and is capable of detecting the operation by touch operation for the respective display areas. The display module 201 comprises the second display screen g capable of displaying a plurality of operating area images that make the operating areas corresponding to the respective display areas of the first display screen G identifiable on the touch panel t. The display module 201 further comprises the touch panel t arranged on the second display screen g side.

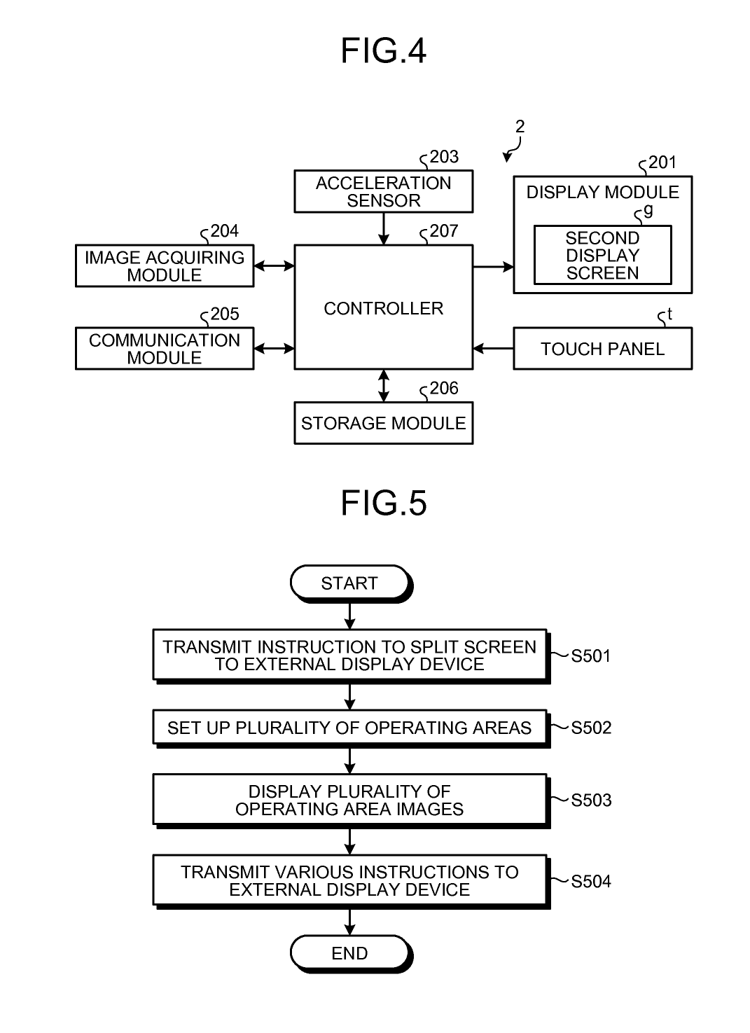

FIG. 4 is a block diagram illustrating a hardware configuration of the operating device in the first embodiment. The operating device 2 in the first embodiment comprises, as illustrated in FIG. 4, the display module 201, the touch panel t, an acceleration sensor 203, an image acquiring module 204, a communication module 205, a storage module 206, and a controller 207. Although not illustrated, the operating device 2 further comprises a speaker, a microphone, and/or the like.

The display module 201 is a display device comprising the second display screen g composed of, for example, a liquid crystal display (LCD) and an organic electro luminescence (EL) display. The display module 201 displays a variety of information under the control of the controller 207.

The touch panel t is an input device that detects the operation by touch operation to receive various instructions and information input from a user. In the first embodiment, the touch panel t is a transparent coordinate detecting device disposed in a laminated manner on the second display screen g of the display module 201, and is split into a plurality of operating areas corresponding to the display areas of the first display screen G split and being capable of detecting the operation by touch operation for the respective display areas.

The acceleration sensor 203 is a sensing device that senses the acceleration exerted to the own device. The acceleration sensor 203 is an example of a detector that outputs, for example, the fluctuations in the posture (inclination and rotation) of the own device in three axial directions as a sensing result.

The image acquiring module 204 is a camera capable of acquiring an image of a subject.

The communication module 205 is a communication interface capable of connecting to a network such as the Internet (not depicted). The communication module 205, under the control of the controller 207, transfers a variety of information with an external device (for example, the external display device 1) connected to the network.

The storage module 206 comprises a nonvolatile storage medium such as a read only memory (ROM), a hard disk drive (HDD), and a solid state drive (SSD). The storage module 206 stores therein various computer programs, setting information, and others.

The controller 207 comprises a central processing unit (CPU), a random access memory (RAM), and the like (none illustrated). The controller 207 collaborates with the programs stored in the storage module 206 to control the overall operation of the operating device 2.

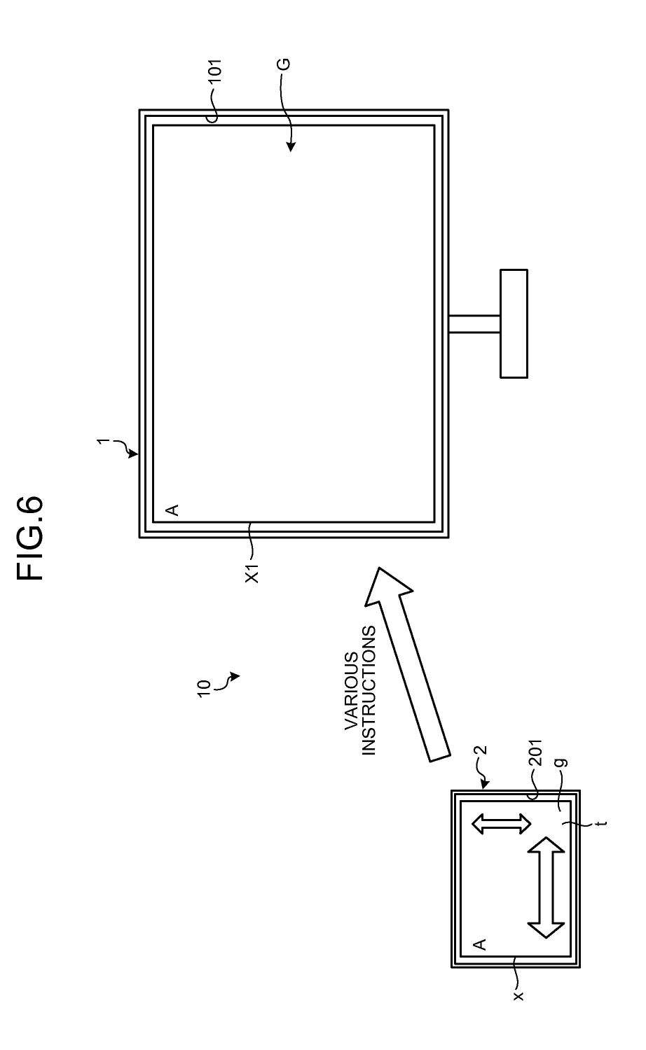

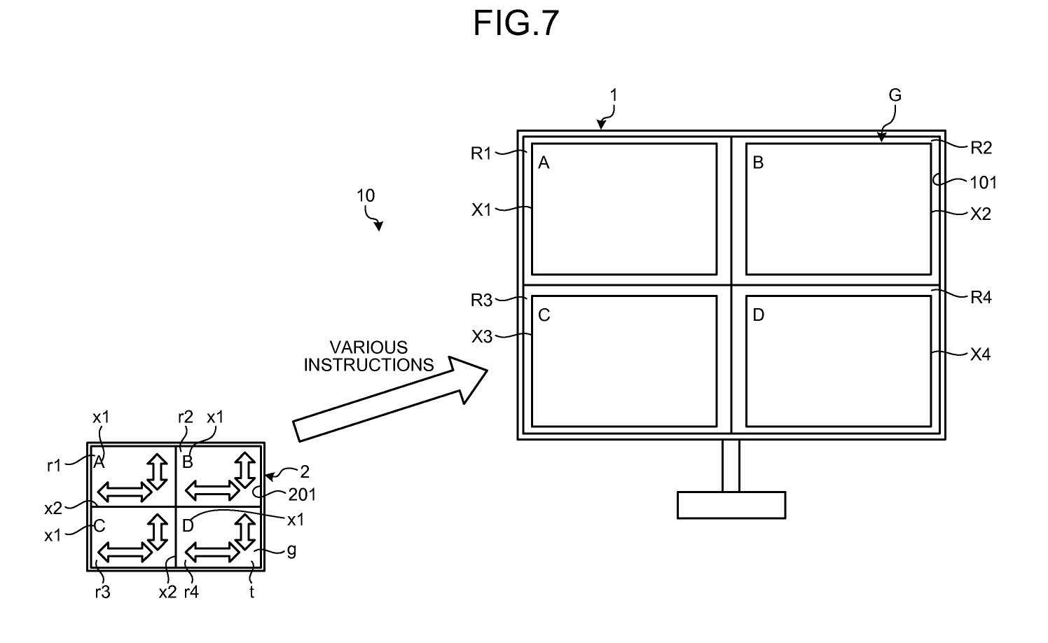

Next, with reference to FIGS. 5 to 7, described will be a process performed by the operating device 2 to control the display on the first display screen G comprised in the external display device 1 in the first embodiment. FIG. 5 is a flowchart illustrating a sequence of the process to control the display on the first display screen of the external display device performed by the operating device in the first embodiment. FIGS. 6 and 7 are diagrams illustrating examples of the first display screen of the external display device and the second display screen of the operating device in the display control system in the first embodiment.

When a split screen instruction is not received from the operating device 2, the external display device 1, as illustrated in FIG. 6, provides a single display area on the first display screen G (in the first embodiment, the entire first display screen G), and displays a variety of display information X1 (for example, broadcast video on a channel A selected in advance) in the display area.

At that time, the controller 207 of the operating device 2 provides, as illustrated in FIG. 6, a single operating area (in the first embodiment, the entire touch panel t) that allows the operation for the display area provided on the first display screen G to be input. The operating device 2 further displays an operating area image that makes the operating area recognizable (in the first embodiment, a frame x that surrounds the operating area) on the second display screen g.

When the operation by touch operation of flicking in the up-and-down direction of the operating area (see FIG. 6) is detected within the operating area provided on the touch panel t (the frame x displayed on the second display screen g), the controller 207 transmits a change instruction by which changing in the volume of sound concerning the display information X1 displayed on the first display screen G is instructed, to the external display device 1.

Furthermore, when the operation by touch operation of flicking in the left-right direction of the operating area (see FIG. 6) is detected within the operating area provided on the touch panel t, the controller 207 transmits a change instruction by which switching of the display information X1 displayed on the first display screen G (in the first embodiment, switching of the broadcast video on the channel A displayed as the display information X1) is instructed, to the external display device 1.

While the controller 207 transmits various instructions including the change instructions to the external display device 1 when a flick is detected as the operation by touch operation on the touch panel t in the first embodiment, the embodiment is not limited thereto. For example, when the controller 207 detects the operation by touch operation of pressing various buttons (not depicted) included within the frame x on the second display screen g, the controller 207 may transmit the instructions that correspond to the respective buttons.

When the operation by touch operation by which the splitting of the first display screen G is instructed is detected by the touch panel t (or when the splitting of the first display screen G is instructed by a not-illustrated split instructing button comprised in the operating device 2 being depressed), the controller 207 transmits a split screen instruction to the external display device 1 (S501). In the first embodiment, when the operation by touch operation by which the splitting of the first display screen G is instructed is detected by the touch panel t, the controller 207 receives the input of the number of splits to split the first display screen G into. The controller 207 then transmits, to the external display device 1, a split screen instruction that includes the number of splits (for example, four) of the input received and the layout information indicative of the layout of the display areas to be split by the number of splits .

When the external display device 1 receives the split screen instruction from the operating device 2, as illustrated in FIG. 7, the external display device 1 splits the first display screen G by the number of splits (for example, four) included in the split screen instruction received, and provides a plurality of display areas R1, R2, R3, and R4. The external display device 1 further displays a variety pieces of display information X1 to X4 (for example, broadcast videos on channels A to D selected in advance) in the display areas R1, R2, R3, and R4, respectively. When the received split screen instruction includes the layout information, the external display device 1 arranges the display areas R1, R2, R3, and R4 on the first display screen G according to the layout indicated in the layout information. In the following description, the display areas R1, R2, R3, and R4 are described as a display area R or display areas R collectively when it is not necessary to specify the individual display areas R1, R2, R3, and R4.

When the controller 207 transmits the split screen instruction to the external display device 1, as illustrated in FIG. 7, the controller 207 splits the touch panel t by the number of splits (for example, four) included in the split screen instruction, and provides a plurality of operating areas r1, r2, r3, and r4 (S502). The operating areas r1, r2, r3, and r4 here, as illustrated in FIG. 7, are the areas that correspond to the respective display areas R, which are the first display screen G of the external display device 1 being split, and allow the operation by touch operation for the display areas R to be detected. In the following description, the operating areas r1, r2, r3, and r4 are described as an operating area r or operating areas r collectively when it is not necessary to specify the individual operating areas r1, r2, r3, and r4.

In the first embodiment, the controller 207 arranges the operating areas r corresponding to the respective display areas R on the first display screen G according to the layout indicated in the layout information included in the split screen instruction, and thus arranges the operating areas r in the same layout as that of the display areas R on the first display screen G. In the first embodiment, the controller 207 further provides the operating areas r corresponding to the respective display areas R to be in the same shape as those of the respective display areas R on the first display screen G.

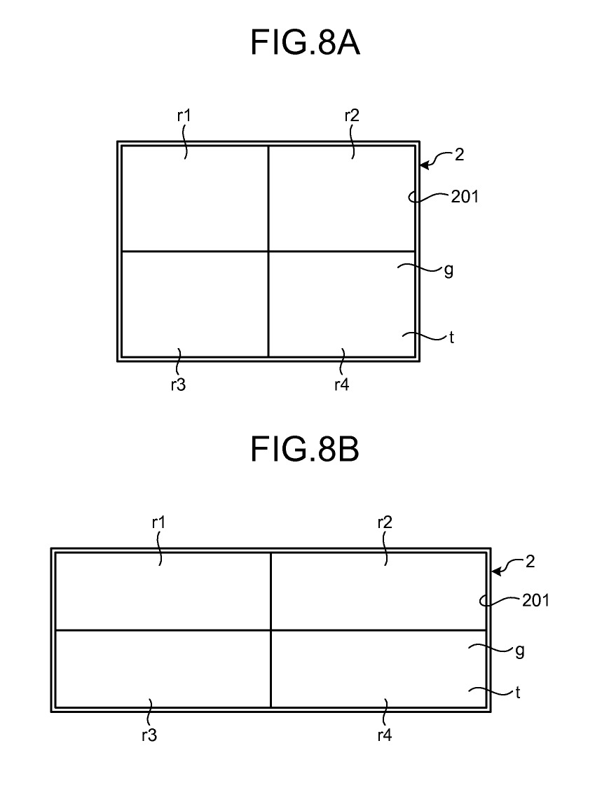

FIGS. 8A and 8B are diagrams illustrating examples of the operating areas that the touch panel of the operating device has in the first embodiment. When the first display screen G of the external display device 1 is split into four display areas R (see FIG. 7), as illustrated in FIG. 8A, the controller 207 arranges the layout of the four operating areas r corresponding to the respective display areas R as the same layout as that of the display areas R on the first display screen G. Furthermore, when the aspect ratio of the first display screen G and the aspect ratio of the touch panel t are the same, as illustrated in FIG. 8A, the controller 207 makes the aspect ratio of each of the operating areas r the same as those of the respective display areas R so as to make the shape of the operating areas r the same as those of the display areas R. Consequently, the correspondence relation between each of the display areas R that are the first display screen G being split and each of the operating areas r that are the touch panel t being split can be perceived more easily.

However, when the aspect ratio of the first display screen G and the aspect ratio of the touch panel t are largely different from each other, as illustrated in FIG. 8B, the controller 207 arranges the layout of the four operating areas r corresponding to the respective display areas R so as to be the same as that of the display areas R on the first display screen G. While the shape of each of the display areas R on the first display screen G and the shape of each of the operating areas r on the touch panel t are different from each other in this case, because the layout of the four operating areas r corresponding to the respective display areas R is the same as that of the display areas R on the first display screen G, the correspondence relation between each of the display areas R that are the first display screen G being split and each of the operating areas r that are the touch panel t being split can be perceived easily.

While the controller 207 provides a plurality of operating areas r by splitting the entire touch panel t when the first display screen G of the external display device 1 is split into the display areas R in the first embodiment, the controller 207 may split a portion of the touch panel t into a plurality of operating areas r.

Furthermore, while the controller 207 splits the touch panel t by the number of splits included in the split screen instruction to provide the operating areas r in the first embodiment, the embodiment is not limited thereto. For example, when the external display device 1 can split the first display screen G into a plurality of display areas R in response to a split screen instruction from the remote controller (not depicted) other than the operating device 2, the controller 207 (an acquiring module) acquires the number of splits of the first display screen G from the external display device 1 via the communication module 205. The controller 207 then provides the operating areas r of the number of splits acquired on the touch panel t.

The controller 207 further acquires the layout information indicating the layout of the display areas R on the first display screen G from the external display device 1 via the communication module 205. The controller 207 then arranges the operating areas r corresponding to the respective display areas R, which are the first display screen G being split, on the touch panel t according to the acquired layout information.

Returning back to FIG. 5, when the touch panel t is split into the operating areas r, the controller 207 controls the display module 201 to display, on the second display screen g, a plurality of operating area images that make the operating areas r on the touch panel t identifiable (S503). In the first embodiment, the controller 207 displays identification information x1 that identifies the display information displayed in the display areas R corresponding to the respective operating areas r on the touch panel t (for example, channel information of A to D for the broadcast videos displayed on the display areas R) as the operating area images on the second display screen g. In the first embodiment, the controller 207 further displays boundary information x2 indicating boundaries between the operating areas r that are the touch panel t being split as the operating area images on the second display screen g.

While the controller 207 displays the identification information x1 and the boundary information x2 on the second display screen g as the operating area images in the first embodiment, as long as the operating area images make the operating areas r of the touch panel t identifiable, the operating area images are not limited to these. For example, the controller 207 may display frames or the like that surround the respective operating areas r of the touch panel t as the operating area images on the second display screen g.

Subsequently, when an operation by touch operation is detected in any of the operating areas r provided on the touch panel t, the controller 207 transmits various instructions to the external display device 1 in response to the operation by touch operation detected (S504).

More specifically, when the operation by touch operation by which the switching of the display information displayed in the display area R corresponding to the operating area r is instructed is detected in any of the operating areas r of the touch panel t, the controller 207 (transmitter) transmits a change instruction by which the changing of the display information displayed in the display area R corresponding to the operating area r is instructed, to the external display device 1.

For example, as illustrated in FIG. 7, when an operation to flick in the left-right direction is detected in the operating area r1 that is identified by A of the identification information x1 as the operation by touch operation, the controller 207 transmits a change instruction to switch the broadcast video on the channel A (display information X1) displayed in the display area R1 corresponding to the operating area r1, in which the operation by touch operation is detected, to the broadcast video on another channel. When operations to flick in the left-right direction are detected in the operating areas r2, r3, and r4 that are identified by B, C, and D of the identification information x1, respectively, as the operation by touch operation, as illustrated in FIG. 7, the controller 207 transmits change instructions to switch the broadcast videos to those on other channels in the same manner.

Furthermore, when the operation by touch operation by which changing in the volume of sound concerning the display information displayed in the display area R corresponding to the operating area r is instructed is detected in any of the operating areas r of the touch panel t, the controller 207 transmits a change instruction by which the changing in the volume of sound concerning the display information displayed in the display area R corresponding to the operating area r is instructed, to the external display device 1.

For example, as illustrated in FIG. 7, when an operation to flick in the up-and-down direction is detected in the operating area r1 identified by A of the identification information x1 as the operation by touch operation, the controller 207 transmits a change instruction that changes the volume of the sound on the channel A. Here, the channel A is for the broadcast video displayed in the display area R1 corresponding to the operating area r1 in which the operation by touch operation is detected. When operations to flick in the up-and-down direction are detected in the operating areas r2, r3, and r4 that are identified by B, C, and D of the identification information x1, respectively, as the operation by touch operation, as illustrated in FIG. 7, the controller 207 transmits change instructions by which the changing of the volume of sound is instructed, in the same manner. In the first embodiment, the external display device 1 produces only the sound concerning the display information displayed in any one of the display areas R on the first display screen G, and thus when the volume of the sound concerning the display information displayed in the display area R corresponding to the operating area r in which the operation by touch operation is detected is made greater than 0 (zero), the external display device 1 changes the volume of the sound concerning the display information displayed in the other display areas R to 0 (zero).

Moreover, the controller 207 switches the target of operation for an operation by touch operation with respect to the display area R between the operating area r at which the operation by touch operation is detected and all of the display areas R, in accordance with the location of the operation by touch operation detected on the touch panel t. In the first embodiment, when a location on the touch panel t at which the operation by touch operation is detected fits within a single operating area r, the controller 207 specifies, as the target of the operation by touch operation, the display area R that corresponds to the operating area r in which the operation by touch operation is detected. Meanwhile, when the location in which the operation by touch operation is detected on the touch panel t continues to a number of operating areas r, the controller 207 specifies, as the target of the operation by touch operation, all of the display areas R.

For example, as illustrated in FIG. 7, when an operation to flick in the left-right direction is detected only in the operating area r1 that is identified by A of the identification information x1 as the operation by touch operation, the controller 207 specifies the display area R1 in which the display information X1 (broadcast video on the channel A) is displayed as the display area R of the target of operation to switch to the broadcast video on another channel. Meanwhile, when an operation to flick in the left-right direction is detected in the operating area r1 with A of the identification information x1 and the operating area r2 with B of the identification information x1 in series as the operation by touch operation, the controller 207 specifies all of the display areas R as the display area R of the target of operation to switch to the broadcast videos on other channels.

Alternatively, the controller 207 may switch the target of operation by the touch operation with respect the display area R between the operating area r at which the operation by touch operation is detected and all of the display areas R, in accordance with the posture of the operating device 2 detected by the acceleration sensor 203 or the like. In that case, the acceleration sensor 203 serves as a detector that detects the posture of the operating device 2. In the first embodiment, when the acceleration sensor 203 detects that the long side of the operating device 2 (or the second display screen g) is turned sideways, the controller 207 specifies, as the target of the operation by the touch operation, the display area R that corresponds to the location of the operating area r in which the operation by touch operation is detected. Meanwhile, when the acceleration sensor 203 detects that the long side of the operating device 2 (or the second display screen g) is turned vertical, the controller 207 specifies the entire display areas R as the target of the operation by the touch operation.

Furthermore, when an operation by touch operation by which resizing of the operating area r on the touch panel t is instructed is detected, the controller 207 transmits a change instruction by which the resizing of the display area R corresponding to the resized operating area r is instructed, to the external display device 1. Consequently, the size of the display area R corresponding to the resized operating area r is changed in response to the resizing of the operating area r, and thus the operation to resize the display area R can be performed on the operating device 2 intuitively.

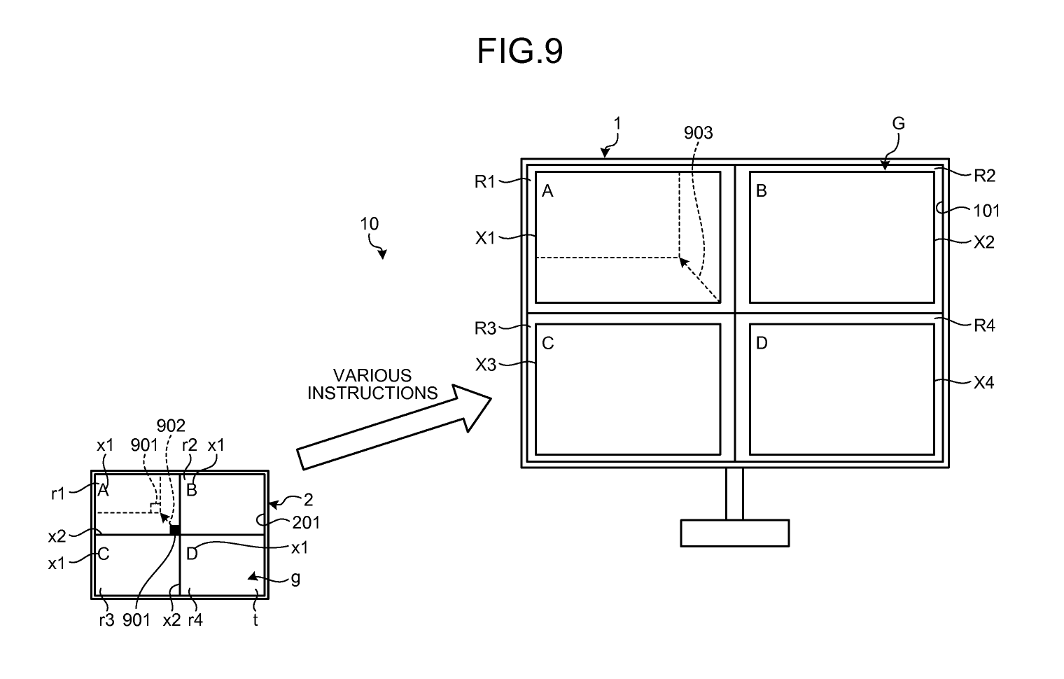

FIG. 9 is a diagram for explaining the operation to resize the display area in accordance with the resizing of the operating area in the display control system in the first embodiment. While the operation to reduce the size of the display area R in accordance with the reduction in the size of the operating area r is explained in the following description, the operation to expand the size of the display area R in response to the expansion in the size of the operating area r is performed in a similar manner.

As illustrated in FIG. 9, upon detection of the operation by touch operation by which the reduction (changing) of the size of the operating area r1 identified by A of the identification information x1 is instructed by moving a corner 901 of the operating area r1 identified by A of the identification information x1 in the direction of an arrow indicated by the reference numeral 902, the controller 207 transmits a change instruction by which the reduction (changing) of the size of the display area R (the display area R1 in which the broadcast video on the channel A is displayed as the display information X1) corresponding to the operating area r1 that is reduced (changed) in size is instructed, to the external display device 1. Consequently, as illustrated in FIG. 9, the external display device 1 reduces (changes), in response to the change instruction received from the operating device 2, the size of the display area R1 in which the broadcast video on channel A is displayed as the display information X1 in the direction of an arrow indicated by the reference numeral 903.

While the controller 207 transmits the change instruction by which the resizing of only the display area R1 corresponding to the operating area r1 having the changed size is instructed, to the external display device 1 when the operation by touch operation by which the resizing of the operating area r1 identified by A of the identification information x1 is instructed is detected in the first embodiment, the embodiment is not limited thereto.

For example, upon detection of the operation by touch operation by which the reduction (changing) of the size of the operating area r1 identified by A of the identification information x1 is instructed by moving the intersection of the boundary information x2 on the second display screen g in the direction of the arrow indicated by the reference numeral 902, the controller 207 further transmits change instructions by which the resizing of the other operating areas r to be resized (the operating areas r2, r3, and r4 identified by B, C, and D of the identification information x1, respectively) along with the operating area r having the changed size (the operating area r1 identified by A of the identification information x1) is instructed, to the external display device 1. The external display device 1 then, in accordance with the change instructions received from the operating device 2, expands (changes) the sizes of the display areas R2, R3, and R4 in which the respective pieces of the display information X2, X3, and X4, respectively, are displayed along with the reduction (change) of the display area R1 in which the broadcast video on the channel A is displayed as the display information X1.

While the controller 207 detects the moving of the corner 901 of the operating area r1 as the operation by touch operation by which the resizing of the operating area r1 is instructed in the first embodiment, the embodiment is not limited thereto. For example, the controller 207 may detect the action of, by placing a plurality of fingers on an operating area r to resize, something like stretching out the operating area r (what is called pinch-out) or something like picking up the operating area r (what is called pinch-in) as the operation by touch operation by which the resizing of the operating area r is instructed.

Furthermore, when the operation by touch operation by which the changing in the layout of the operating areas r is instructed is detected, the controller 207 transmits, to the external display device 1, a change instruction by which the changing in the layout of the display areas R such that the display areas R are arranged in the same layout as that of the operating areas r after the change is instructed.

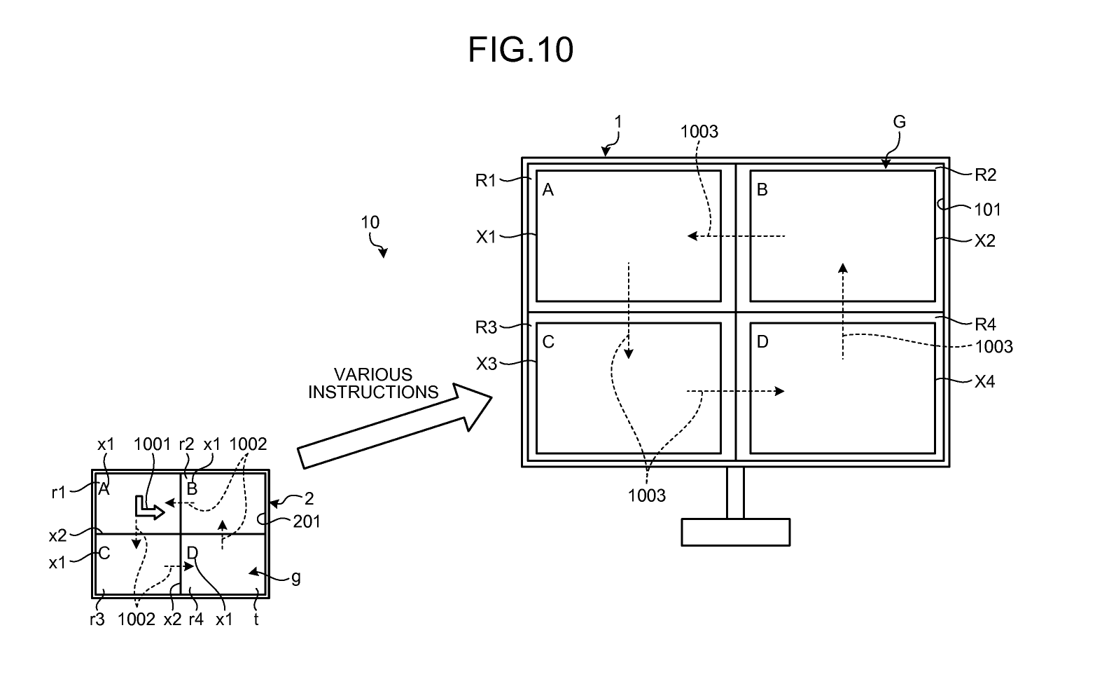

FIG. 10 is a diagram for explaining the operation to change the layout of the display areas in accordance with the change in the layout of the operating areas in the display control system in the first embodiment. In the first embodiment, when the operation by touch operation of an operation 1001 tracing any of the operating area r in L-shape to specify the arrangement of the operating areas r1, r2, r3, and r4 to be rotated in the counter-clockwise direction as indicated by the reference numeral 1002 is detected, the controller 207 transmits, to the external display device 1, a change instruction that instructs the display areas R to be rotated in the counter-clockwise direction (indicated by the reference numeral 1003) such that the display areas R are arranged in the same layout as that of the operating areas r rotated in the counter-clockwise direction (indicated by the reference numeral 1002). Consequently, the display areas R in the first display screen G can be arranged in the same layout as that of the operating areas r on the second display screen g, and thus the change in the layout of the display areas R on the first display screen G can be performed intuitively, thereby making it unnecessary to select the operating area r in which the operation for the display area R of the target of operation can be input.

As in the foregoing, according to the first embodiment, when operation by touch operation by which the resizing of the operating area r of the touch panel 5 is instructed is detected, a change instruction by which resizing of the display area R corresponding to the operating area r having its size changed is transmitted to the external display device 1. Consequently, a size of the display area R corresponding to the operating area r having its size changed is changed in accordance with the resizing of the operating area r. Thus, it is possible to intuitively perform operation for resizing the display area R in the operating device 2.

### First Modification

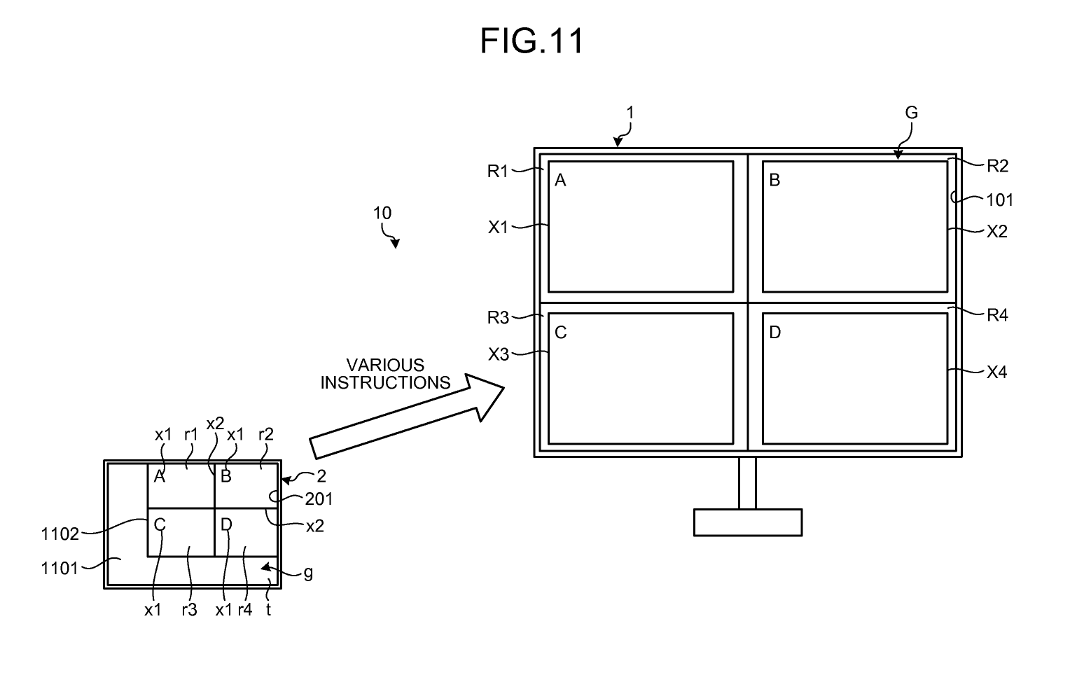

A first modification is an example of the following case. In particular, a plurality of operating areas r are provided on a portion of the second display screen g of the operating device 2. Then, in response to whether the area in which the operation by touch operation is detected is an operating area r or an area 1101 (see FIG. 11) other than the operating areas r, the target of the operation by the touch operation is switched between the display area R corresponding to the operating area r at which the operation by the touch operation is detected and the entire display areas R. In the following description, only the points different from those in the first embodiment will be described.

FIG. 11 is a diagram for explaining the operation to switch the target of operation between a single display area and all of the display areas in a display control system according to the first modification. In the first modification, the controller 207 provides a plurality of operating areas r on a portion of the touch panel t, and specifies the L-shaped area 1101 on the touch panel t other than the operating areas r as an area to input the operation for the operating areas r. When the area 1101 is provided on the touch panel t, the controller 207 displays an image that makes the area 1101 identifiable (in the first modification, second boundary information 1102 indicative of the boundary between the operating areas r and the area 1101) on the second display screen g.

When the location in which an operation by touch operation is detected on the touch panel t is in the operating areas r, the controller 207 specifies, as the target of the operation by touch operation, the display area R that corresponds to the operating area r in which the operation by touch operation is detected. Meanwhile, when the location in which an operation by touch operation is detected on the touch panel t is in the area 1101, the controller 207 specifies all of the display area R as the target of the operation by touch operation.

Furthermore, in the first modification, when the operation by touch operation of an operation tracing the area 1101 in L-shape instructs the layout of the operating areas r to be rotated in the counter-clockwise direction, the controller 207 transmits, to the external display device 1, a change instruction instructing the display areas R to be rotated in the counter-clockwise direction (indicated by the reference numeral 1003 in FIG. 10) such that the display areas R are arranged in the same layout as that of the operating areas r rotated in the counter-clockwise direction (indicated by the reference numeral 1002 in FIG. 10).

As in the foregoing, in accordance with the first modification, a plurality of operating areas r are provided on a portion of the second display screen g of the operating device, and the target of the operation by touch operation is switched between the display area R corresponding to the operating area r at which the operation by touch operation is detected and all of the display areas R, in accordance with whether the area in which the operation by touch operation is detected is the operating areas r or the area 1101 other than the operating areas r. As a consequence, because the area to input for a single display area R and the area to input for all of the display areas R are different, the target of the operation by touch operation performed on a single operating area r can be prevented from being switched to the display areas R accidentally.

### Second Modification

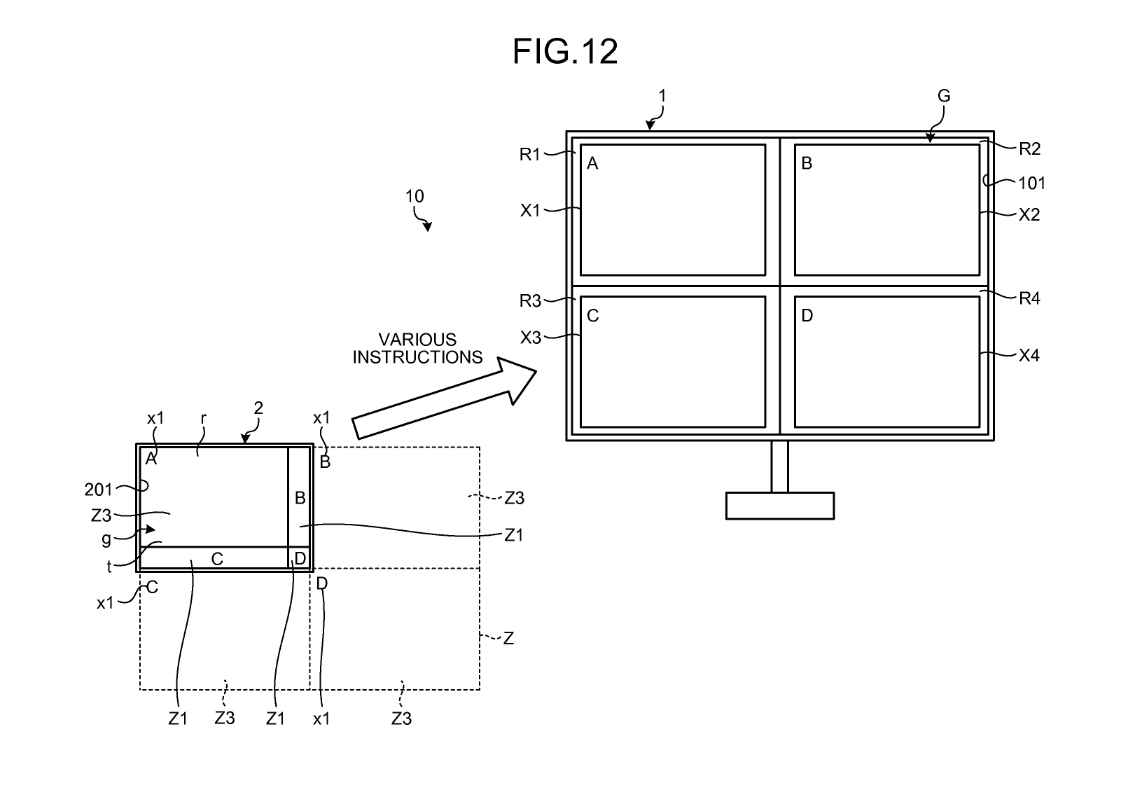

A second modification is an example of displaying, on the second display screen g, a portion of an image Z (see FIG. 12) that includes a plurality of operating area images (the identification information x1) and is larger than the display size displayable on the second display screen g. In the following description, only the points different from those in the first embodiment will be described.

FIG. 12 is a diagram illustrating a display example of an image for a second display screen of an operating device according to the second modification. In the second modification, the controller 207 draws the image Z that includes A to D of the identification information x1 and is larger than the display size displayable on the second display screen g as an example of a plurality of operating area images in the storage module 206. The controller 207 then controls the display module 201 to display a portion of the image Z drawn in the storage module 206 on the second display screen g. In the second modification, the controller 207 splits the image Z into a plurality of partial images Z3 by the number of splits equivalent to the number of operating areas r, and makes the respective partial images Z3 displayed on the second display screen g.

In the second modification, the controller 207 further comprises, on the partial images Z3 displayed on the second display screen g out of the partial images Z3, instruction buttons Z1 that can specify the display of the other partial images Z3. The controller 207 then switches the partial images Z3 out of the image Z to be displayed on the second display screen g in response to the operation by touch operation for the instruction button Z1 in the operating area r of the target of operation.

As in the foregoing, in accordance with the second modification, a part of the image Z that includes a plurality of operating area images and is larger than the display size displayable on the operating device 2 is displayed on the second display screen g. This allows the operating area images that make the operating areas r identifiable to be displayed on the second display screen g larger than when the operating area images are displayed on a single screen, thereby making it easier to input the operation for the display area R.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processor comprising:
a touch panel configured to correspond to each of a plurality of display areas and be capable of detecting an operation by touch operation with respect to the display areas, a first display screen of an external display device being split as the display areas;
a display comprising a second display screen displaying a plurality of operating area images configured to make operating areas corresponding to the respective display areas identifiable on the touch panel, the touch panel being arranged on a second display screen side; and
a transmitter configured to transmit, upon detection of the operation by which changing a size of at least one of the operating areas is instructed, a change instruction by which changing a size of at least one of the display areas corresponding to the at least one of the operating areas having the changed size is instructed, to the external display device.

2. The information processor of claim 1, wherein, the transmitter is configured to transmit, upon detection of the operation by which changing a size of one of the operating areas is instructed, the change instruction by which changing a size of one of the display areas corresponding to the one of the operating areas having the changed size is transmitted.

3. The information processor of claim 2, wherein the transmitter is configured to transmit, upon detection of the operation by which changing a size of the one of the operating areas is instructed, the change instruction by which changing a size of other one of the display areas corresponding to other one of the operating areas having a changed size in accordance with the one of the operating areas for which the size is changed.

4. The information processor of claim 1, wherein the transmitter is configured to transmit, upon detection of the operation by which changing a layout of the at least one of the operating areas is instructed, the change instruction by which changing a layout of at least one of the display areas is instructed so that the at least one of the display areas is to be arranged in a manner similar to a layout of the at least one of the operating areas after the changing.

5. The information processor of claim 1, wherein the transmitter is configured to transmit, upon detection of the operation by which changing of display information of one of the display areas is instructed at one of the operating areas, the change instruction by which changing of the display information of the one of the display areas corresponding to the one of the operating areas is instructed.

6. The information processor of claim 1, wherein the display is configured to display, on the second display screen, a portion of an image comprising the operating area images and is larger than a display size displayable on the second display screen.

7. The information processor of claim 1, further comprising:
an acquiring module configured to acquire a number of splits of the first display screen from the external display device, wherein
the touch panel comprises the operating areas of the number of splits acquired by the acquiring module.

8. The information processor of claim 7, wherein
the acquiring module is configured to acquire layout information indicating a layout of the display areas on the first display screen from the external display device, and
the touch panel comprises the operating areas arranged according to the layout information acquired by the acquiring module.

9. The information processor of claim 1, wherein the transmitter switches a target of the operation between the at least one of the display areas corresponding to the at least one of the operating areas at which the operation is detected and all of the display areas, in accordance with a position at which the operation is detected.

10. The information processor of claim 1, further comprising:
a detector configured to detect a posture of the information processor, wherein
the transmitter is configured to switch a target of the operation between the at least one of the display areas corresponding to the at least one of the operating areas at which the operation is detected and all of the display areas, in accordance with the detected posture of the information processor.

11. A display control method performed by an information processor comprising a touch panel and a display module, the touch panel being configured to correspond to each of a plurality of display areas and being capable of detecting an operation by touch operation with respect to the display areas, a first display screen of an external display device being split as the display areas, the display module comprising a second display screen displaying a plurality of operating area images configured to make operating areas corresponding to the respective display areas identifiable on the touch panel, the touch panel being arranged on a second display screen side, the display control method comprising
transmitting, by a transmitter and upon detection of the operation by which changing a size of at least one of the operating areas is instructed, a change instruction by which changing a size of the at least one of the display areas corresponding to the at least one of the operating areas having the changed size is instructed, to the external display device.
